(19) United States
(12) Patent Application Publication
(10) Pub. No.: US 2006/0152480 A1
(43) Pub. Date: Jul. 13, 2006

(54) Handheld electronic device, user interface and method employing an input wheel disposed at about a 45 degree angle

(75) Inventor: Jeffrey A. Senn, Pittsburgh, PA (US)

Correspondence Address: MARTIN J. MORAN, ESQ.;Eaton Electrical, Inc., Technology & Quality Center, 170 Industry Drive, RIDC Park West, Pittsburgh, PA, 15275-1032, US

(73) Assignee: EATON CORPORATION

(21) Appl. No.: 11/035,255

(22) Filed: Jan. 13, 2005

(51) Int. Cl. G09G 5/00

(52) U.S. Cl. 345/156

(57) ABSTRACT

A handheld electronic device, such as a fob, includes an input apparatus having a single rotational axis and a thumbwheel adapted to rotate about the rotational axis in a first rotational direction and an opposite second rotational direction. A display alternatively displays a first horizontal list and a second vertical list. The horizontal list includes a plurality of first objects, such as icons, disposed in a first longitudinal direction, and the vertical list includes a plurality of second objects, such as menu items, disposed in a different second longitudinal direction. A microprocessor cooperates with the input apparatus and the display to scroll the icons or the menu items responsive to rotation of the thumbwheel in the first rotational direction or the opposite second rotational direction. The rotational axis is disposed at an angle of 45 degrees with respect to the first longitudinal direction and to the different second longitudinal direction.

### BACKGROUND OF THE INVENTION

1. Field of the Invention

This invention pertains generally to handheld electronic devices and, more particularly, to handheld electronic devices employing a display and an input wheel, such as a thumbwheel. The invention also relates to user interfaces and methods employing a display and an input wheel.

2. Background Information

Numerous types of handheld electronic devices are known. Examples of such handheld electronic devices include, for instance, personal digital assistants (PDAs), handheld computers, two-way pagers, cellular telephones, and the like. Many handheld electronic devices also feature wireless communication capability, although many such handheld electronic devices are stand-alone devices that are functional without communication with other devices.

It is known to employ a thumbwheel with a handheld electronic device to control menus for the selection of functions, such as, for example, data input.

It is further known to employ a vertical list, such as a vertical menu of menu items for program and/or function selection in handheld electronic devices. For example, rotation of a handheld electronic device thumbwheel for a vertical menu navigates displayed menu items in an up-to-down or down-to-up fashion depending upon the direction of rotation.

It is also known to employ vertical and/or horizontal arrays of icons for program and/or function selection in handheld electronic devices. For example, rotation of a handheld electronic device thumbwheel for a horizontal array of icons navigates between displayed icons in a left-to-right or right-to-left fashion depending upon the direction of rotation.

There is room for improvement in handheld electronic devices, user interfaces and methods employing an input wheel and a display adapted to alternatively display horizontal lists and vertical lists.

### SUMMARY OF THE INVENTION

These needs and others are met by the present invention, which provides a method of directly mapping both horizontal and vertical scrolling through an input wheel in an ad hoc manner to provide unambiguous results.

In accordance with one aspect of the invention, a handheld electronic device comprises: an input apparatus comprising a single rotational axis and a wheel adapted to rotate about the single rotational axis in a first rotational direction and an opposite second rotational direction; a display alternatively displaying a first list and a second list, the first list including a plurality of first objects disposed in a first longitudinal direction, the second list including a plurality of second objects disposed in a different second longitudinal direction; and a processor component cooperating with the input apparatus and the display to scroll the first objects or the second objects responsive to rotation of the wheel in the first rotational direction or the opposite second rotational direction, wherein the single rotational axis is disposed at an angle of about 45 degrees with respect to the first longitudinal direction and to the second longitudinal direction.

The first rotational direction and the opposite second rotational direction may define a longitudinal axis which is normal to the single rotational axis. The display may comprise a planar display surface, a horizontal axis and a vertical axis. The longitudinal axis may be parallel to the planar display surface, and the angle may be 45 degrees with respect to the horizontal axis and to the vertical axis.

The first rotational direction may correspond to upward and leftward; the second rotational direction may correspond to downward and rightward; the horizontal list may be adapted to scroll leftward responsive to rotation of the wheel in the first rotational direction and to scroll rightward responsive to rotation of the wheel in the second rotational direction; and the vertical list may be adapted to scroll upward responsive to rotation of the wheel in the first rotational direction and to scroll downward responsive to rotation of the wheel in the second rotational direction.

As another aspect of the invention, a user interface for a handheld electronic device comprises: an input apparatus comprising a single rotational axis and a wheel adapted to rotate about the single rotational axis in a first rotational direction and an opposite second rotational direction; and a display adapted to alternatively display a first list and a second list, the first list including a plurality of first objects disposed in a first longitudinal direction, the second list including a plurality of second objects disposed in a different second longitudinal direction, wherein the single rotational axis is disposed at an angle of about 45 degrees with respect to the first longitudinal direction and to the second longitudinal direction, and wherein the display is adapted to scroll the first objects or the second objects responsive to rotation of the wheel in the first rotational direction or the opposite second rotational direction.

As another aspect of the invention, a user interface method comprises: employing an input apparatus comprising a single rotational axis and a wheel adapted to rotate about the single rotational axis in a first rotational direction and an opposite second rotational direction; alternatively displaying a first list and a second list, the first list including a plurality of first objects disposed in a first longitudinal direction, the second list including a plurality of second objects disposed in a different second longitudinal direction; disposing the single rotational axis at an angle of about 45 degrees with respect to the first longitudinal direction and to the second longitudinal direction; and scrolling the first objects or the second objects responsive to rotation of the wheel in the first rotational direction or the opposite second rotational direction.

The method may employ a horizontal list as the first list and a vertical list as the second list.

The method may employ a plurality of objects in one of the horizontal list and the vertical list, and may select one of the objects.

### BRIEF DESCRIPTION OF THE DRAWINGS

A full understanding of the invention can be gained from the following description of the preferred embodiments when read in conjunction with the accompanying drawings in which:

FIG. 1 is a plan view of a fob in accordance with the present invention.

FIG. 2 is a plan view of the thumbwheel and the display of the fob of FIG. 1 including a horizontal list of icons.

FIG. 3 is a plan view of the thumbwheel and the display of the fob of FIG. 1 including a vertical menu.

FIG. 4 is a block diagram of the fob of FIG. 1.

FIG. 5 is a plan view of another fob, which has been rotated 180 degrees for use by a left-handed person, in accordance with another embodiment of the invention.

### DESCRIPTION OF THE PREFERRED EMBODIMENTS

As employed herein, the term “wireless” shall expressly include, but not be limited by, radio frequency (RF), infrared, wireless area networks, IEEE 802.11 (e.g., 802.11a; 802.11b; 802.11g), IEEE 802.15 (e.g., 802.15.1; 802.15.3, 802.15.4), other wireless communication standards, DECT, PWT, pager, PCS, Wi-Fi, Bluetooth™, and cellular.

As employed herein, the term “portable wireless communicating device” shall expressly include, but not be limited by, any portable communicating device having a wireless communication port (e.g., a portable wireless device; a portable personal computer (PC); a Personal Digital Assistant (PDA); a data phone).

As employed herein, the term “fob” shall expressly include, but not be limited by, a portable wireless communicating device; a wireless network device; a handheld electronic object that is directly or indirectly carried by a person; a handheld electronic object that is worn by a person; a handheld electronic object that is placed on or coupled to a household object (e.g., a refrigerator; a table); a handheld electronic object that is coupled to or carried by a personal object (e.g., a purse; a wallet; a credit card case); and/or a portable handheld electronic object.

As employed herein, the term “handheld electronic device” shall expressly include, but not be limited by, a fob and/or other wireless or non-wireless handheld electronic objects.

As employed herein, the term “wheel” shall expressly include, but not be limited by, any circular-shaped, disk-shaped, drum-shaped, spherically-shaped or other structure resembling a wheel in shape or motion that is adapted to rotate about a single rotational axis.

The present invention is described in association with a fob, although the invention is applicable to a wide range of handheld electronic devices.

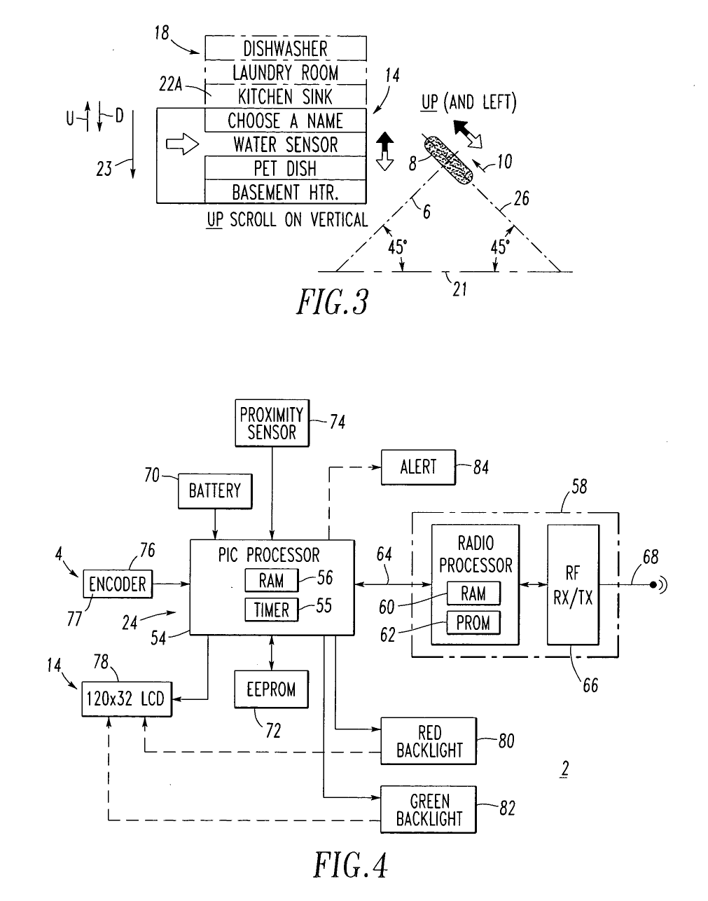

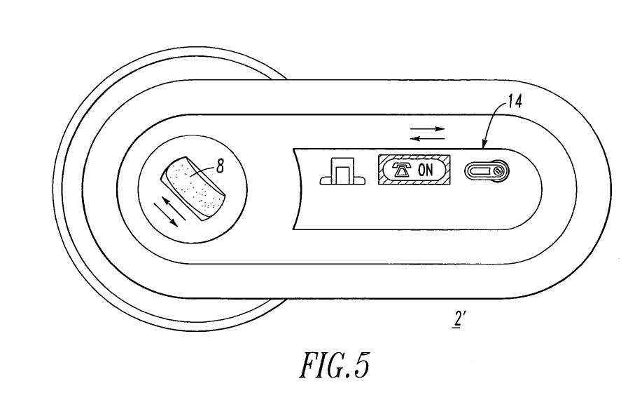

Referring to FIG. 1, a handheld electronic device, such as the example fob 2, is shown. The fob 2 includes an input apparatus 4 having a single rotational axis 6 (shown in hidden line drawing) and a wheel, such as a thumbwheel 8, adapted to rotate about the rotational axis 6 in a first rotational direction 10 and an opposite second rotational direction 12. The fob 2 further includes a display 14 alternatively displaying a first list 16 (FIG. 1) and a second list 18, as shown in FIG. 3. The example first list 16 includes a plurality of first objects, such as icons 20, disposed in a first longitudinal direction 21 (e.g., horizontal as shown in FIG. 1). The example second list 18 includes a plurality of second objects, such as menu items 22 (FIG. 3), disposed in a different second longitudinal direction 23 (e.g., vertical as shown in FIG. 3). The fob 2 also includes a suitable processor component 24 (as best shown in FIG. 4) cooperating with the input apparatus 4 and the display 14 to scroll the first objects or the second objects responsive to rotation of the thumbwheel 8 in the first rotational direction 10 or the opposite second rotational direction 12. As shown in FIG. 1, the rotational axis 6 is disposed at an angle of about 45 degrees with respect to the first or horizontal longitudinal direction 21 and to the second or vertical longitudinal direction 23.

Although the first list 16 includes the icons 20, any suitable object, such as menu items may be employed. Although the second list 18 includes the menu items 22, any suitable object, such as icons, may be employed.

Although example displays are shown in FIGS. 1-3, the thumbwheel 8 might, for example, alternatively be employed in a modal fashion, in order to scroll both horizontally as well as vertically through a text or graphic display (not shown) that does not (otherwise) fit on the display 14. For example, vertical/horizontal selection might be done “modally” (i.e., through another control (e.g., a button press, such as button 77) that switches the mode between horizontal and vertical).

Although horizontal and vertical longitudinal directions 21,23 are shown, any two normal longitudinal directions disposed at or about a 45 degree angle with respect to a suitable rotational axis, such as 6, may be employed. In the example of FIG. 1, the first rotational direction 10 and the opposite second rotational direction 12 define a longitudinal axis 26 of the thumbwheel 8, which longitudinal axis is normal to the rotational axis 6.

The example display 14 includes a planar display surface 28, a horizontal axis disposed in the first longitudinal direction 21 and a vertical axis disposed in the second longitudinal direction 23. The thumbwheel longitudinal axis 26 is parallel to the planar display surface 28 and is preferably at 45 degrees with respect to the horizontal and vertical axes of the display 14. The rotational axis 6 is parallel to, or co-planar with, the planar display surface 28.

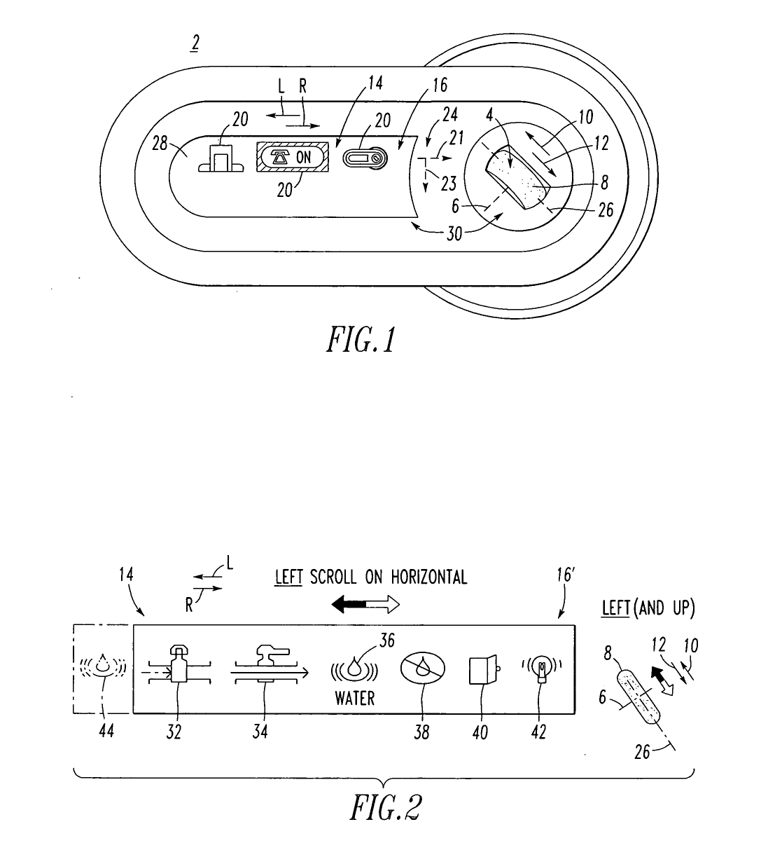

The first rotational direction 10 corresponds to leftward (L) scrolling as shown in FIGS. 1 and 2 and upward (U) scrolling as shown in FIG. 3, while the second rotational direction 12 corresponds to rightward (R) scrolling as shown in FIGS. 1 and 2 and downward (D) scrolling as shown in FIG. 3. The horizontal lists 16,16′ of FIGS. 1 and 2 are adapted to scroll leftward responsive to rotation of the thumbwheel 8 in the first rotational direction 10 and to scroll rightward responsive to rotation of the thumbwheel 8 in the second rotational direction 12. The vertical list 18 of FIG. 3 is adapted to scroll upward responsive to rotation of the thumbwheel 8 in the first rotational direction 10 and to scroll downward responsive to rotation of the thumbwheel 8 in the second rotational direction 12.

A user interface 30 for the fob 2 includes the input apparatus 4 and the display 14, as shown. The rotational axis 6 is preferably disposed at an angle of 45 degrees with respect to the first and second longitudinal directions 21,23. The display 14 is adapted to scroll the first objects 20 or the second objects 22 (FIG. 3) responsive to rotation of the thumbwheel 8 in the first or second rotational directions 10,12.

FIG. 2 shows the fob display 14 including the example horizontal list 16′ of items, such as the example icons 32,34,36,38,40,42 and the icon 44 (shown in phantom line drawing). This configuration provides a direct mapping of the direction of rotation (e.g., toward the upper left of FIG. 2; toward the bottom right of FIG. 2) with the direction of scrolling (toward the left of FIG. 2; toward the right of FIG. 2) on the display 14.

The example icon 32 shows that the corresponding wireless device (not shown) is a closed water valve, while the icon 34 shows that the corresponding device (not shown) is an open water valve. The icon 36 shows that the corresponding wireless sensor (not shown) has detected water, while the icon 38 shows that the corresponding sensor (not shown) has not detected water. Similarly, the icon 40 shows that the corresponding wireless door sensor (not shown) has detected an open door, while the icon 42 shows that the corresponding appliance or light sensor (not shown) has detected an energized appliance or light. In this example, the leftmost icon 44 is not shown in the fob display 14 until the thumbwheel 8 is suitably rotated left (and up) in the rotational direction 10 until that icon 44 is displayed and the rightmost icon 42 is scrolled off of the display.

Double-clicking on one of the device icons, such as 32,34, causes the corresponding device to change state. For example, double-clicking on the icon 32 causes the closed water valve to open, while double-clicking on the icon 34 causes the open water valve to close. In this manner, the horizontal list 16′ may be employed to monitor a remote device or sensor through the icons 32,34,36,38,40,42,44 or to control a remote device through the icons 32,34.

FIG. 3 shows the fob display 14 including the vertical list 18 of items, such as the example menu items 22. This configuration provides a direct mapping of the direction of rotation (e.g., toward the upper left of FIG. 3; toward the bottom right of FIG. 3) with the direction of scrolling (toward the top of FIG. 3; toward the bottom of FIG. 3) on the display 14.

As is apparent from FIGS. 2 and 3, the diagonal (about 45°) thumbwheel axis 26, which is normal to the rotational axis 6 and parallel or co-planar with the planar display surface 28 (FIG. 1) of the display 14, provides a method of directly mapping both horizontal (FIG. 2) and vertical (FIG. 3) scrolling in an ad hoc manner that advantageously provides unambiguous results for the user.

FIG. 3 shows the example in which the vertical list 18 is employed to configure a remote wireless device (not shown) or a remote wireless sensor (not shown). In this example, the user is given an opportunity to chose a name for a water sensor that might be applied to a pet dish, a basement water heater, a dishwasher, a laundry room or a kitchen sink, to name a few examples of the various menus items 22. In this example, the menu item 22A (shown in phantom line drawing) is not shown in the fob display 14 until the thumbwheel 8 is suitably rotated up (and left) in the rotational direction 10 until that menu item 22A is displayed and the lowermost menu item 20 (e.g., BASEMENT HTR in this example) is scrolled off of the display.

FIG. 4 is a non-limiting example block diagram of the fob 2 of FIG. 1. The example fob 2 includes a first processor 54 (e.g., PIC) having RAM memory 56 and a suitable second radio or RF processor 58 having RAM 60 and PROM 62 memory. The example processor component 24 includes the first and second processors 54,58, which communicate through suitable serial interface (e.g., SCI; SPI) 64. The EEPROM memory 72 is employed to store the unique ID of the fob 2 as well as other nonvolatile information. For example, there may be a nonvolatile storage for icons, character/font sets and labels.

The second processor 58, in turn, employs an RF transceiver (RX/TX) 66 having an external antenna 68. As shown with the processor 54, the various components of the fob 2 receive power from a battery 70. The first processor 54 receives inputs from a timer 55, a suitable proximity sensor, such as a sensor/base/device program switch 74 (e.g., which detects mating or engagement with one of a sensor, device or base station (not shown)), and a user input device, such as, for example, the exemplary encoder 76 or rotary selector/switch, such as a thumbwheel encoder. Typically, such encoder 76 also includes a selector switch, such as a button 77, through which the user presses, clicks and/or double-clicks to initiate actions through the fob user interface 30 (FIG. 1). The button 77 preferably moves in an axis normal to the rotational axis 6 of FIG. 1.

The first processor 54 also sends outputs to a suitable display 78 (e.g., a 120×32 LCD), one or more visual alerts, such as a red backlight 80 (e.g., an alert is present) and a green backlight 82 (e.g., no alert is present) for the display 78, and an alert device 84 (e.g., a suitable audible, visual or vibrating device providing, for example, a sound, tone, buzzer, vibration or flashing light). Although the display 78 is shown, any suitable display alternatively displaying horizontal and vertical lists of objects may be employed.

The encoder 76 may be, for example, an AEC11BR series encoder marketed by CUI Inc. of Beaverton, Oreg. Although the encoder 76 is shown, any suitable input apparatus including a rotary wheel, such as 8 (FIG. 1), may be employed.

FIG. 5 is a plan view of a fob 2′, which is similar to the fob 2 of FIG. 1, except that it has been rotated 180 degrees for use by a left-handed person.

Although the fob 2 employs the processor component 24, it will be appreciated that a combination of one or more of analog, digital and/or single or plural processor-based circuits may be employed.

It will be appreciated that the objects in the horizontal lists 16,16′ may be staggered or offset somewhat in a vertical direction, while the objects in the vertical list 18 may be staggered or offset somewhat in a horizontal direction.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A handheld electronic device comprising:
an input apparatus comprising a single rotational axis and a wheel adapted to rotate about said single rotational axis in a first rotational direction and an opposite second rotational direction;
a display alternatively displaying a first list and a second list, said first list including a plurality of first objects disposed in a first longitudinal direction, said second list including a plurality of second objects disposed in a different second longitudinal direction; and
a processor component cooperating with said input apparatus and said display to scroll said first objects or said second objects responsive to rotation of said wheel in the first rotational direction or the opposite second rotational direction,
wherein said single rotational axis is disposed at an angle of about 45 degrees with respect to said first longitudinal direction and to said second longitudinal direction.

2. The handheld electronic device of claim 1 wherein said wheel is a thumbwheel.

3. The handheld electronic device of claim 1 wherein said first rotational direction and said opposite second rotational direction define a longitudinal axis which is normal to said single rotational axis; wherein said display comprises a planar display surface, a horizontal axis and a vertical axis; wherein said longitudinal axis is parallel to said planar display surface; and wherein said angle is 45 degrees with respect to said horizontal axis and to said vertical axis.

4. The handheld electronic device of claim 1 wherein said first list is a horizontal list and said second list is a vertical list.

5. The handheld electronic device of claim 4 wherein said first rotational direction corresponds to upward and leftward; wherein said second rotational direction corresponds to downward and rightward; wherein said horizontal list is adapted to scroll leftward responsive to rotation of the wheel in said first rotational direction and to scroll rightward responsive to rotation of the wheel in said second rotational direction; and wherein said vertical list is adapted to scroll upward responsive to rotation of the wheel in said first rotational direction and to scroll downward responsive to rotation of the wheel in said second rotational direction.

6. The handheld electronic device of claim 4 wherein said input apparatus further comprises a selector switch adapted to move in an axis normal to said single rotational axis.

7. The handheld electronic device of claim 1 wherein said display comprises a planar display surface; and wherein said single rotational axis is parallel to said planar display surface.

8. The handheld electronic device of claim 1 wherein said display comprises a planar display surface, a horizontal axis and a vertical axis; wherein said single rotational axis is parallel to said planar display surface; and wherein said angle is 45 degrees with respect to said horizontal axis and to said vertical axis.

9. The handheld electronic device of claim 1 wherein said processor component comprises a microprocessor and a wireless transceiver.

10. A user interface for a handheld electronic device, said user interface comprising:
an input apparatus comprising a single rotational axis and a wheel adapted to rotate about said single rotational axis in a first rotational direction and an opposite second rotational direction; and
a display adapted to alternatively display a first list and a second list, said first list including a plurality of first objects disposed in a first longitudinal direction, said second list including a plurality of second objects disposed in a different second longitudinal direction,
wherein said single rotational axis is disposed at an angle of about 45 degrees with respect to said first longitudinal direction and to said second longitudinal direction, and
wherein said display is adapted to scroll said first objects or said second objects responsive to rotation of said wheel in the first rotational direction or the opposite second rotational direction.

11. The user interface of claim 10 wherein said wheel is a thumbwheel.

12. The user interface of claim 10 wherein said first rotational direction and said opposite second rotational direction define a longitudinal axis which is normal to said single rotational axis; wherein said display comprises a planar display surface, a horizontal axis and a vertical axis; wherein said longitudinal axis is parallel to said planar display surface; and wherein said angle is 45 degrees with respect to said horizontal axis and to said vertical axis.

13. The user interface of claim 10 wherein said first rotational direction corresponds to upward and leftward; wherein said second rotational direction corresponds to downward and rightward; wherein said horizontal list is adapted to scroll leftward responsive to rotation of the wheel in said first rotational direction and to scroll rightward responsive to rotation of the wheel in said second rotational direction; wherein said vertical list is adapted to scroll upward responsive to rotation of the wheel in said first rotational direction and to scroll downward responsive to rotation of the wheel in said second rotational direction; wherein said display comprises a planar display surface, a horizontal axis parallel to said horizontal list and a vertical axis parallel to said vertical list; wherein said single rotational axis is parallel to said planar display surface; and wherein said angle is 45 degrees with respect to said horizontal axis and to said vertical axis.

14. A user interface method comprising:
employing an input apparatus comprising a single rotational axis and a wheel adapted to rotate about said single rotational axis in a first rotational direction and an opposite second rotational direction;
alternatively displaying a first list and a second list, said first list including a plurality of first objects disposed in a first longitudinal direction, said second list including a plurality of second objects disposed in a different second longitudinal direction;
disposing said single rotational axis at an angle of about 45 degrees with respect to said first longitudinal direction and to said second longitudinal direction; and
scrolling said first objects or said second objects responsive to rotation of said wheel in the first rotational direction or the opposite second rotational direction.

15. The method of claim 14 further comprising employing a horizontal list as said first list and a vertical list as said second list.

16. The method of claim 15 further comprising employing said horizontal list to monitor a remote sensor or to control a remote device.

17. The method of claim 15 further comprising employing said vertical list to configure a remote sensor or a remote device.

18. The method of claim 15 further comprising employing a plurality of icons in one of said horizontal list and said vertical list.

19. The method of claim 15 further comprising employing a plurality of menu items in one of said horizontal list and said vertical list.

20. The method of claim 15 further comprising employing a plurality of objects in one of said horizontal list and said vertical list; and selecting one of said objects.
